(19) United States
(12) Patent Application Publication
(10) Pub. No.: US 2011/0085195 A1
(43) Pub. Date: Apr. 14, 2011

(54) IMAGE FORMING APPARATUS AND NETWORK SYSTEM

(75) Inventor: Hiroteru Tsuchiya, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/883,669

(22) Filed: Sep. 16, 2010

Related U.S. Application Data
(60) Provisional application No. 61/251,035, filed on Oct. 13, 2009.

(51) Int. Cl. G06K 15/00

(52) U.S. Cl. 358/1.14

(57) ABSTRACT

According to one embodiment, an image forming apparatus including, a storing section configured to store a user name and a password of an authenticated user, an image processing section configured to execute processing instructed by the user, and a managing section configured to permit operation of the image processing section according to the user name and the password of the accessing user.

### CROSS-REFERENCE TO RELATED APPLICATIONS

This application is based upon and claims the benefit of priority from: U.S. Provisional Application No. 61/251,035 filed on Oct. 13, 2009, the entire contents of each of which are incorporated herein by reference.

### FILED

Embodiments described herein relate generally to an image forming apparatus and a network system.

### BACKGROUND

A user (a client) can instruct, from an arbitrary PC (Personal Computer), an arbitrary MFP (an image forming apparatus called Multi-Function Peripheral) located on a network to perform output (printout) of an image. The user (the client) can acquire, via the network, image data read (scanned) by the MFP and apply necessary processing to the image data.

On the other hand, it is a general practice to require authentication for access to the MFP. Further, presence or absence of operation authority is also often set for applications usable by the MFP.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of a network system according to an embodiment;

FIG. 2 is an exemplary diagram showing an example of an MFP according to an embodiment;

FIG. 3 is an exemplary diagram showing an example of an MFP search and user authentication module of the system according to an embodiment;

FIG. 4 is an exemplary diagram showing an example of a screen of an MFP search function in an MFP search and user authentication module of the system according to an embodiment;

FIG. 5 is an exemplary diagram showing an example of an MFP (MFP A) of the system according to an embodiment;

FIG. 6 is an exemplary diagram showing an example of an MFP (MFP B) of the system according to an embodiment;

FIG. 7 is an exemplary diagram showing an example of an MFP (MFP C) of the system according to an embodiment;

FIG. 8 is an exemplary diagram showing an example of an MFP (MFP D) of the system according to an embodiment;

FIG. 9 is an exemplary diagram showing an example of an MFP (MFP E) of the system according to an embodiment;

FIG. 10 is an exemplary diagram showing an example of a flowchart of an MFP search function in the MFP search and user authentication module of the system according to an embodiment;

FIG. 11 is an exemplary diagram showing an example of an application management table of the system MFP according to an embodiment;

FIG. 12 is an exemplary diagram showing an example of a user password management table of the system MFP according to an embodiment;

FIG. 13 is an exemplary diagram showing an example of an application function usable in MFPs by a specific user of the system MFP according to an embodiment; and

FIG. 14 is an exemplary diagram showing an example of an application function usable in MFPs by a specific user of the system MFP according to an embodiment.

### DETAILED DESCRIPTION

In general, according to an embodiment, an image forming apparatus comprising: a storing section configured to store a user name and a password of an authenticated user; an image processing section configured to execute processing instructed by the user; and a managing section configured to permit operation of the image processing section according to the user name and the password of the accessing user.

Embodiments will now be described hereinafter in detail with reference to the accompanying drawings.

An example of an embodiment is explained in detail below with reference to the accompanying drawings.

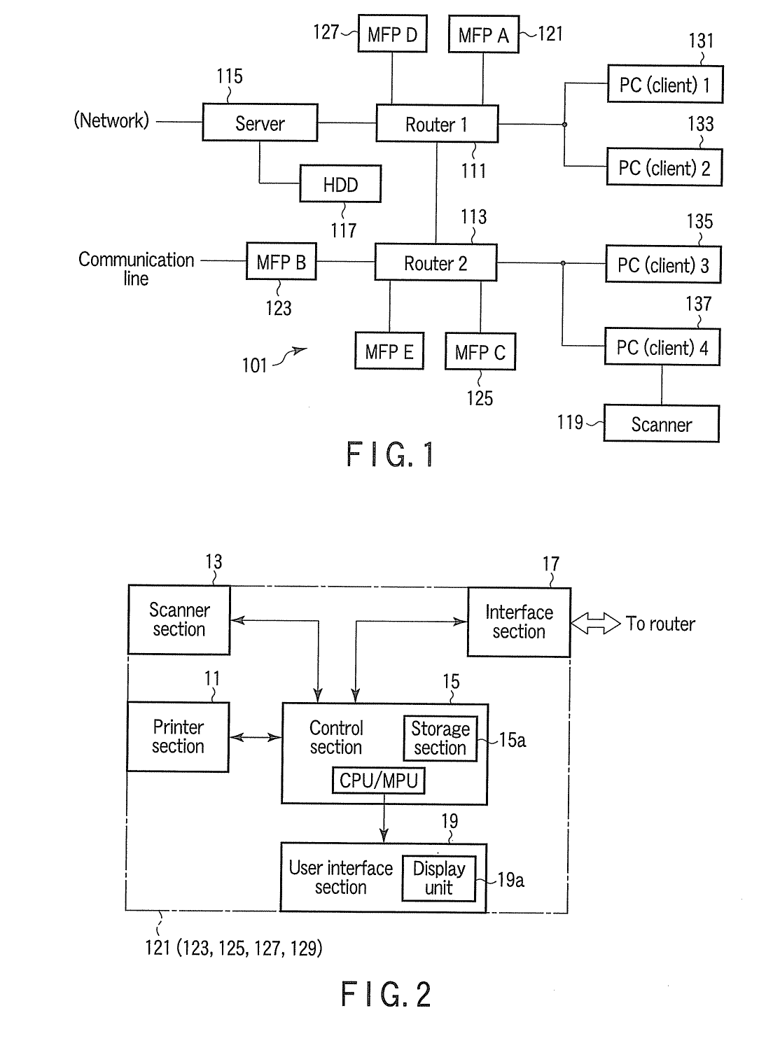

A network 101 shown in FIG. 1 includes plural, for example, two routers 111 and 113 and at least one server 115. The server 115 is desirably connected to an HDD (Hard Disk Drive) 117.

At least one of MFPs (Multi-Functional Peripheral, electronic apparatus) 121 (MFP A), 123 (MFP B), 125 (MFP C), 127 (MFP D), and 129 (MFP E) and at least one of PCs (e.g., personal computers) 131 (client 1), 133 (client 2), 135 (client 3), and 137 (client 4) are connected to each of the routers 111 and 113. An arbitrary MFP imparted with a server function can also serve as the server 115. At least one of the MFPs 121, 123, 125, 127, and 129 desirably preferentially performs output of image information transmitted from the outside through a communication line.

A scanner 119 configured to capture a hardcopy or an image output (a printout) as image information may be connected to arbitrary one or all of the PCs.

As indicated by an example shown in FIG. 2, each of the MFPs 121, 123, 125, 127, and 129 includes a printer section (an image forming section) 11, a scanner section (an image input section) 13, a control section (a control unit) 15, an interface section (a communication unit) 17, and a user interface section (a user interactive unit, an operation section) 19. The user interactive unit 19 includes a display unit 19a configured to display input information. The user interactive unit 19 desirably includes a function of an authentication unit for authentication of a user, for example, a face authentication unit configured to recognize a characteristic of a face of the user, a biometrics authentication unit configured to authenticate a biological characteristic of a palm or a finger of the user, or a card reader configured to use identification information incidental to an ID card or the like.

In each of the MFPs 121, 123, 125, 127, and 129, the image forming section 11 includes, for example, an electrophotographic system, a thermal transfer system, an ink jet system. The image forming section 11 includes a mode that can form a color image. However, in some case, operation is limited for the formation for the color image (color print) (the color print is not permitted to a user).

The image input section 13 photoelectrically converts, for example, reflected light or transmitted light obtained by illuminating a target image or text and obtains image information.

The control unit 15 includes a CPU (Central Processing Unit) or an MPU (Main Processing Unit). The control unit 15 controls, according to a control input received from a client or a server through the user interactive unit 19 or the communication unit 17, image output by the image forming section 11 and acquisition of image information by the image input section 13 and, when necessary, supplies the image information to the communication unit 17. The control unit 15 processes control information (setting) and the like for the image forming section 11, the image input section 13, and the communication unit 17.

The control unit 15 controls, according to a control input received from the router or the server through the communication unit 17, image output by the image forming section 11 and acquisition of image information by the image input section 13 and, when necessary, supplies the image information to the communication unit 17.

The control unit 15 includes a storage section (a storing unit) 15a configured to store control (setting) information, image information, and the like.

The communication unit 17 exchanges control signals, image information, and the like with unspecified PCs (clients) through arbitrary routers 111 and 113. The communication unit 17 exchanges control signals, image information, and the like with the server 115 through the arbitrary routers 111 and 113.

The user interactive unit 19 includes a function of an authentication unit for authentication of a user, permission of image formation and output (a copy function), permission of extraction of a received facsimile document (image output), permission of conditioned image formation and output (output of a printout subjected to confidentiality processing), or permission of editing of operation authority, for example, a face authentication unit configured to recognize a characteristic of a face of the user, a biometrics authentication unit configured to authenticate a biological characteristic of a palm or a finger of the user, or a card reader configured to use identification information incidental to an ID card or the like.

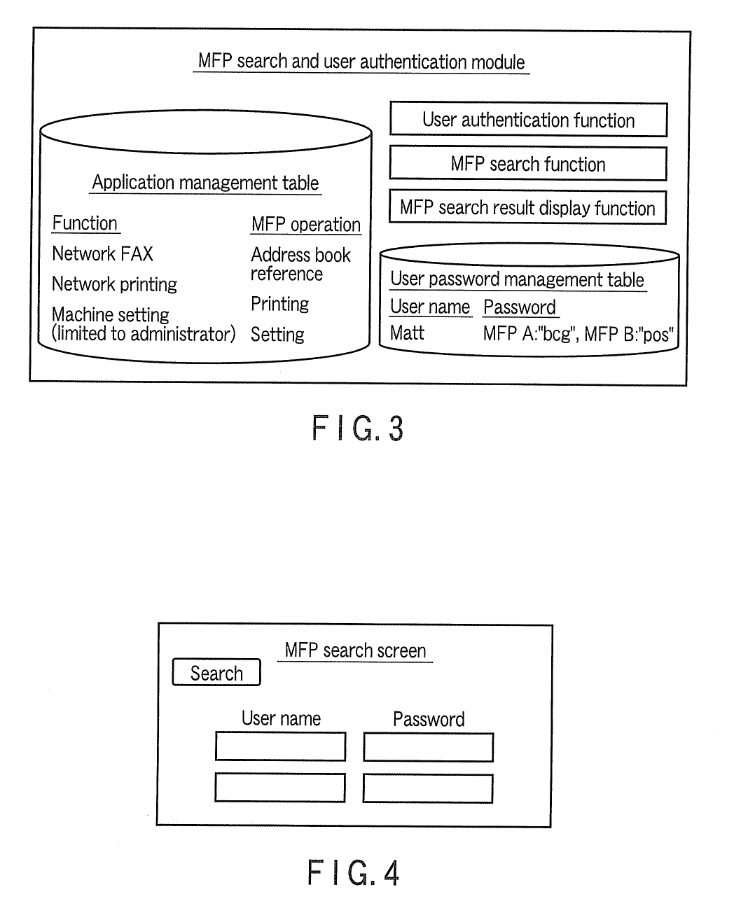

FIG. 3 is a diagram showing an MFP search and user authentication module stored by a server (or an arbitrary MFP having a server function).

An “MFP search function” uses an MFP on a network for search based on a model name of the MFP input by a user (a client). For example, when the user inputs a user name and a password, the user can access an MFP for which operation authority is managed for each user by a “user authentication function” explained later and, in the MFP, search for functions (operation authority) permitted to the user who inputs the user name and the password.

An “MFP search result display function” displays the MFP that can be found in the “MFP search function” and displays a machine name of the found MFP and functions of applications that the user can operate explained later with reference to FIG. 13.

A “user authentication function” is used for authentication processing for the MFP user-managed by the user name and the password and acquisition of authority information for functions in the MFP, use of which is permitted to the user who inputs the user name and the password.

In an “application management table”, functions of applications and necessary operation requested by the MFP to carry out the functions are described. The “application management table” is used for comparing the authority information acquired by the “MFP search function” and the “MFP operation” of this table and determining application functions available to the user.

A “user password management table” is a table in which the user name and the password input by the user and a name of the MFP to which the user successfully logs in.

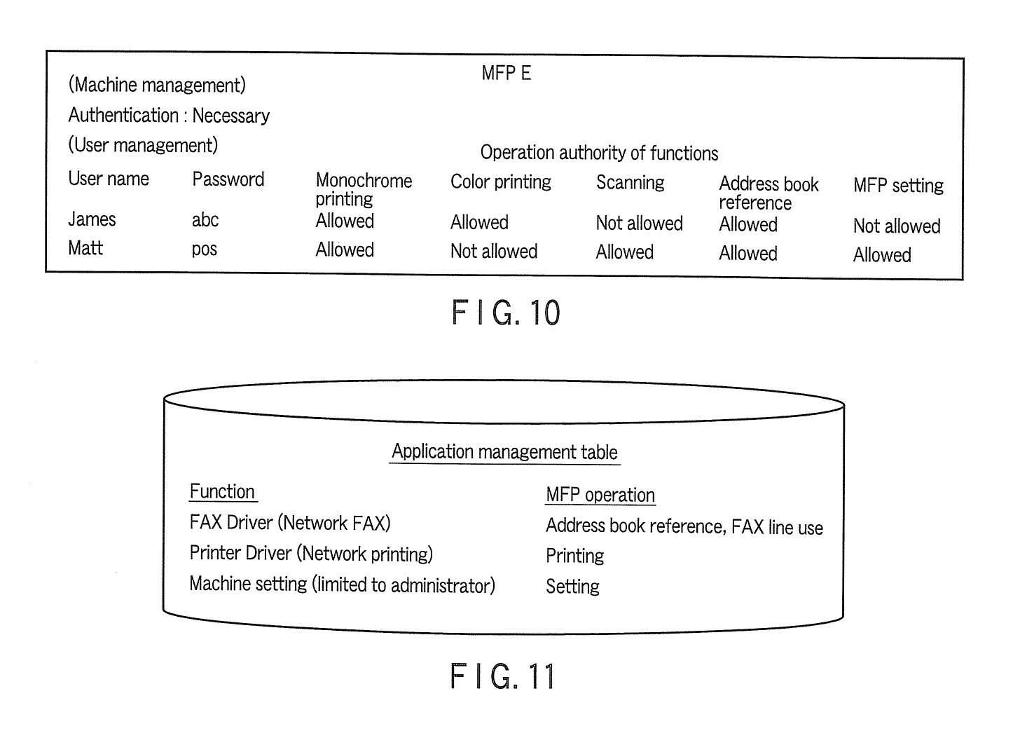

FIG. 4 is a diagram of an example of a screen of an MFP search function in the MFP search and user authentication module of the application shown in FIG. 3. FIG. 10 is a flowchart for explaining more in detail the MFP search function in the MFP search and user authentication module of the application shown in FIG. 3.

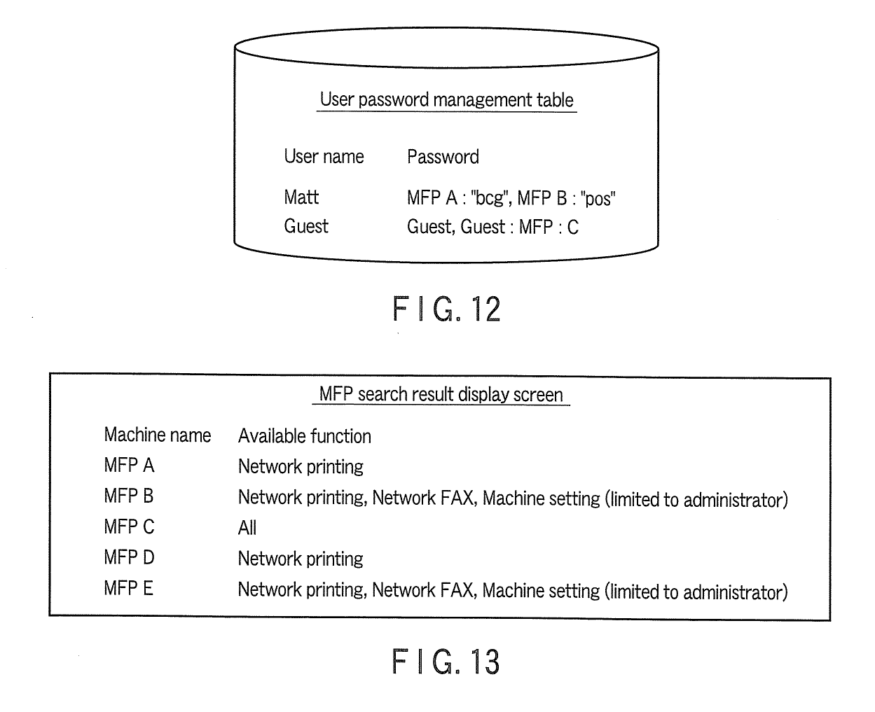

The MFP search and user authentication module of the application shown in FIG. 3 requests a user who attempts to use any one of the MFPs to input a user name and a password necessary for performing authentication for a user-managed MFP among the MFPs and accessing information in the MFP as shown in FIG. 4. However, in the case of connection from a user (a client, a PC) whose user name and password are already stored in the “user password management table” explained later with reference to FIG. 12 [YES in 500], available MFPs and applications specified in the “user password management table” are displayed to the connected user (the PC) (who issues a print request) [5XX]. However, even for the user whose user name and password are already stored in the “user password management table”, for example, when a predetermined period (for example, 90 days) elapses from the last access, the MFP search and user authentication module can request the user to input a user name and a password in an authentication process at a later stage.

Referring to FIG. 10, in the case of a print request from a user (a client, a PC) whose user name and password are recorded [NO in 500], the MFP search and user authentication module of the application (see FIG. 3) requests the user who attempts to use the MFP to input a user name and a password (as shown in FIG. 4) [501].

If the user name or the password or both are not input according to the request [NO in 502], the MFP search and user authentication module performs search for an MFP on the network only with an MFP model name [511].

In this case, the MFP search and user authentication module does not display the MFP A (121 in FIG. 1), the MFP B (123 in FIG. 1), the MFP D (127 in FIG. 1), and the MFP E (129 in FIG. 1) having the user authentication function. The MFP search and user authentication module finds the MFP C (125 in FIG. 1) not having the user authentication function and displays an MFP name and available application names to the user (the PC) [512].

If the user who attempts to use the MFP inputs a user name and a password [YES in 502], the MFP search and user authentication module logs in using the input user name and password [503]. If the search and user authentication module of the application succeeds in the login (the login is successful) [YES in 504], the MFP search and user authentication module acquires information concerning available operation authority on the basis of the input user name and the password [506]. The MFP search and user authentication module performs matching of functions of the available operation authority and functions provided by the application and displays a matching result on an MFP search result display screen [507]. The “user name and password” are stored and overwritten in the “user password management table” explained later with reference to FIG. 12. The user name and the password input once are stored in the “user password management table” in this way. This makes it possible to eliminate necessity of inputting the user name and the password again when the user uses the application later.

If the search and user authentication module of the application fails in the login (the login is unsuccessful) [NO in 504], the MFP search and user authentication module displays indication that there is no available operation authority on the MFP search result display screen (of the PC of the connected user) [505].

More specifically, in [501] in FIG. 10, the MFP search and user authentication module displays an input screen of the MFP search function shown in FIG. 1, specifically, the MFP search screen shown in FIG. 4 and requests the user to input a user name and a password.

Thereafter, for example, if a user “Matt” inputs a user name “Matt” and a password “pos” and the user name “Matt” and a password “bcg” in [502], the search and user authentication module of the application attempts login to the user authentication function explained above with reference to FIG. 3 using the user name and the passwords input by the user [503] in addition to a model name to search for the MFP on the network.

When the login is successful [YES in 504], the search and user authentication module of the application proceeds to [506] and acquires operation authority information available to “Matt”.

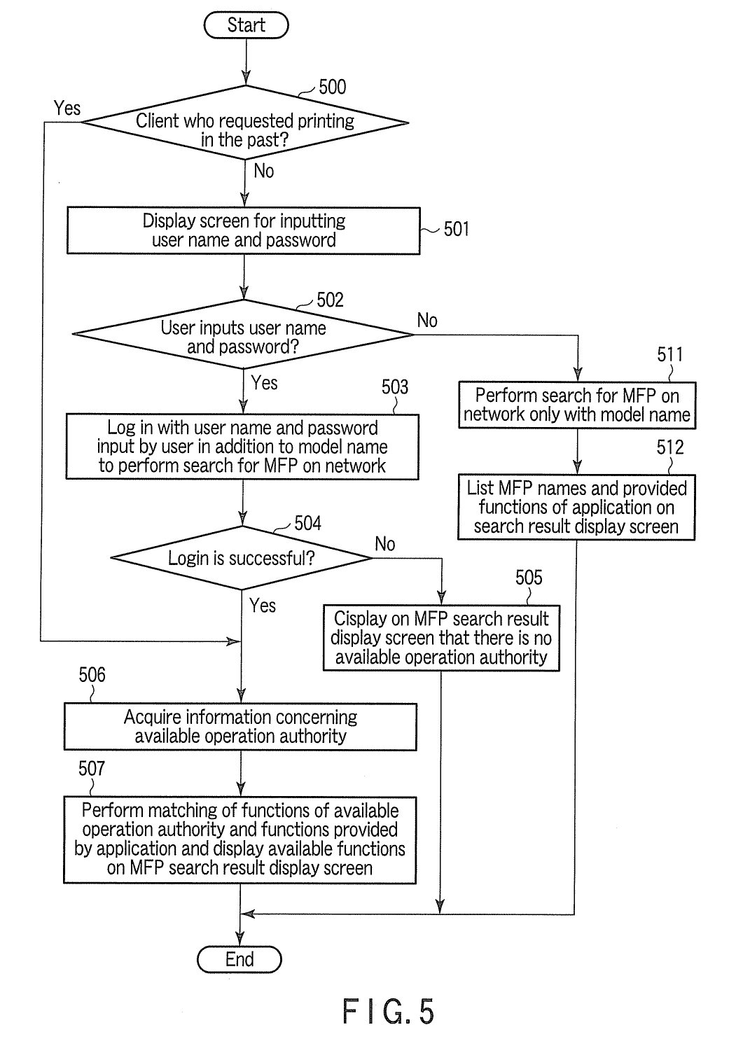

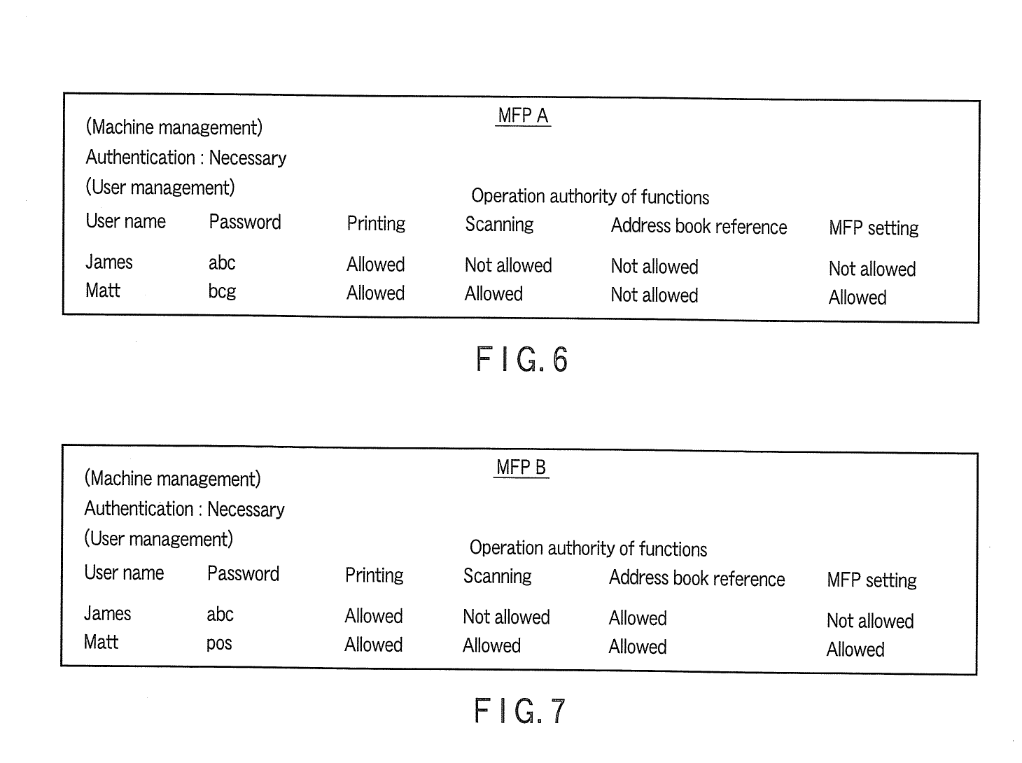

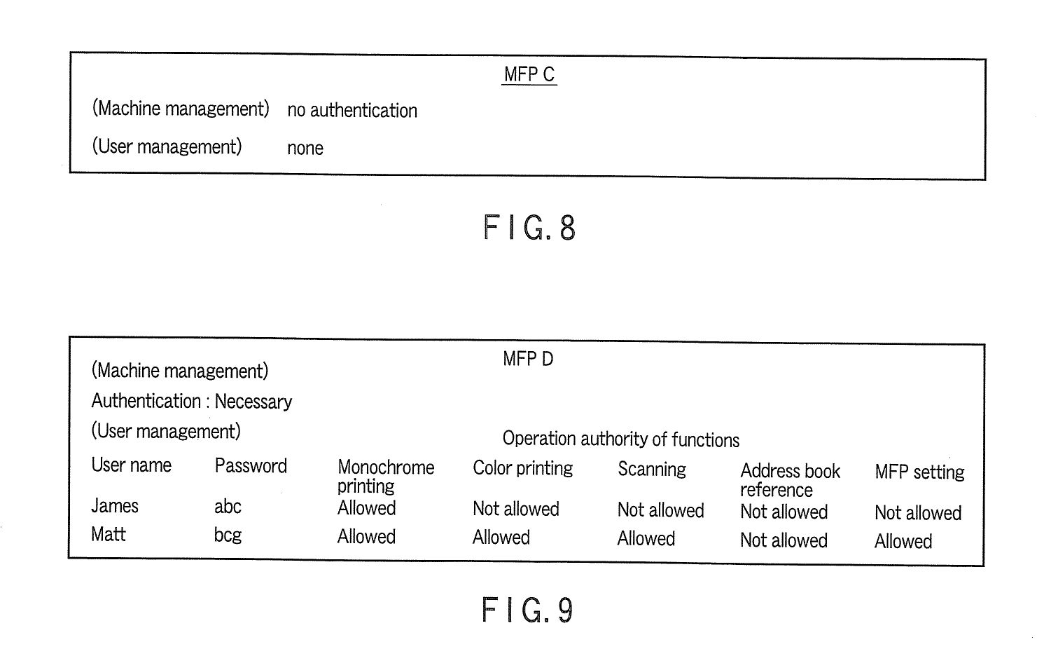

For example, as shown in FIG. 5, the search and user authentication module of the application acquires information “printing”, “scanning”, and “MFP setting” from the MFP A (121 in FIG. 1). As shown in FIG. 6, the search and user authentication module of the application acquires information “printing”, “scanning”, “address book reference”, and “MFP setting” from the MFP B (123 in FIG. 1). Similarly, concerning the MFP C (125 in FIG. 1), as shown in FIG. 7, the search and user authentication module of the application acquires “no function limitation”. As shown in FIG. 8, the search and user authentication module of the application acquires information “printing” and “scanning” from the MFP D (127 in FIG. 1). As shown in FIG. 9, the search and user authentication module of the application acquires information “printing”, “scanning”, “address book reference”, and “MFP setting” from the MFP E (129 in FIG. 1).

Subsequently, the search and user authentication module of the application performs matching of the information acquired in [507] and items of MFP operation of the “application management table” shown in FIG. 3 and determines application functions available to “Matt”. As indicated by an example shown in FIG. 13, the search and user authentication module of the application displays application functions that the specific user (“Matt”) can use in the MFPs.

FIG. 5 is a diagram showing an example of an MFP for which each of users with whom the search and user authentication module communicates has operation authority. For example, in the machine of the MFP A, a user “James” logs in with a password “abc” to be given authority for using a function “printing” and not given authority for using functions “scanning”, “address book reference”, and “MFP setting”.

The user “Matt” logs in with the password “bcg” to be given authority for using the functions “printing”, “scanning”, and “MFP setting” and not given authority for using the function “address book reference”.

FIG. 6 is a diagram showing an example of an MFP having operation authority for each of the users with whom the search and user authentication module communicates. For example, in the machine of the MFP B, the user “James” logs in with the password “abc” to be given authority for using the functions “printing” and “address book reference” and not given authority for using the functions “scanning” and “MFP setting”.

The user “Matt” logs in with the pass words “pos” to be given authority for using all the functions “printing”, “scanning”, “MFP setting”, and “address book reference”. “MFP setting” is operation that an administrator of the MFP should execute. “Matt” has authority for the operation.

The administrator can set, in the MFP search and user authentication module explained above (shown in FIG. 3), a change (addition and deletion) of an authentication target user, permission and non-permission of “Guest (see FIG. 12)”, and the like, at arbitrary timing.

FIG. 7 means that the MFP is a normal MFP that does not require authentication, management of authority, and the like.

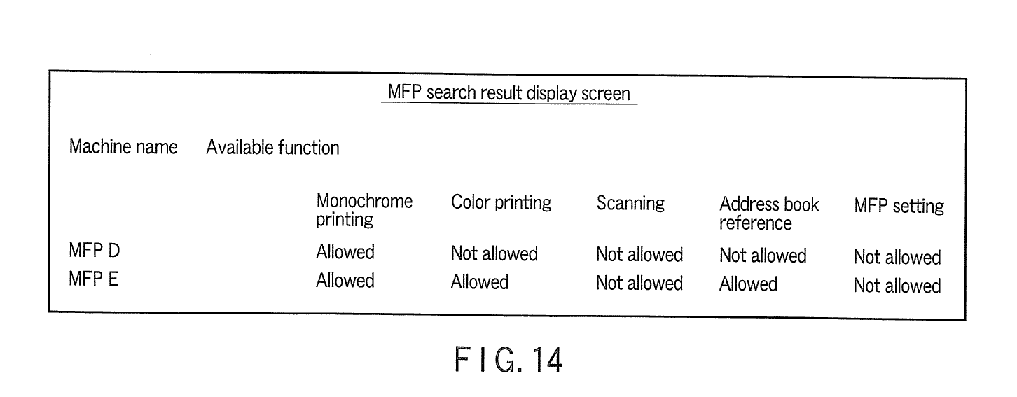

FIGS. 8 and 9 respectively indicate that functions available in the MFP D (127 in FIG. 1) are “printing” and “scanning” and functions available in the MFP E (129 in FIG. 1) are “printing”, “scanning”, “address book reference”, and “MFP setting”. FIGS. 8 and 9 are diagrams of examples in which operation authority for monochrome printing and color printing functions are limited to “allowed” and “not allowed” depending on users. FIG. 14 is a diagram showing a screen for a search result of the MFP search function in the MFP search and user authentication module notified (displayed) to a PC of the user “James”.

FIG. 13 is a table showing, for each of MFPs, functions available to “Matt” according to FIGS. 5 to 9.

It is recognized in the table that a network printing function can be used for the MFP A (121 in FIG. 1), the network printing function and a network facsimile function can be used for the MFP B (123 in FIG. 1), there is no limit for the MFP C (125 in FIG. 1), the network printing function (with limitation on the number of output sheets) can be used for the MFP D (127 in FIG. 1), and the network printing function (including color), the network facsimile function, and “scanning”, “address book reference”, and “MFP setting” can be used for the MFP E (129 in FIG. 1).

FIG. 11 is a diagram for explaining an application management table.

In the application management table, application names are shown as “function” and operation necessary for an MFP when the functions act in association with the MFP is shown as “MFP operation”.

For example, a “facsimile driver (a network facsimile)” needs to use an address stored in the MFP. Therefore, authority for “address book reference” and “facsimile communication” is necessary. A “printer driver (network printing)” is managed as “printing” because a function of the printer driver is realized when printing operation can be carried out in the MFP.

FIG. 12 is a diagram showing an example of a “user password management table (user name and password storing unit)”.

When a user name and a password input once on the MFP search screen shown in FIG. 4 of the application are stored and searched in the next and subsequent times, there is an effect that labor and time for user input is saved by extracting the user name and the password from this storing unit and displaying the same on the MFP search screen.

“Guest” (FIG. 12) mainly indicates a user who is not given a password and is permitted to use an MFP only for a fixed period. For example, when an MFP is set to be permitted to perform color printing, “Guest” is effective when the user searches for the MFP imparted with color printing authority.

As explained above, the application of the embodiment eliminates complicated operation in which, after searching for an MFP present on the network, a user connects a PC of the user to the MFP in an application that the user desires to use, inputs a user name and a password, and, after authentication, can determine whether the user can use the MFP or the administrator of the MFPs informs the user of an MFP having functions that the user is permitted to use and the user connects the PC to the informed MFP in the application that the user desires to use.

When the embodiment is applied, the administrator only has to set an MFP that the user is permitted to use and does not need to inform the user of the MFP. Moreover, the user does not need to perform operation for MFP search, user authentication, and determination concerning whether the user can use a function that the user desire to use in an application. In particular, a user authenticated (for use) in the past can use, only by connection from a PC (issuance of a printing request), an MFP and an application that the user is permitted to use in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a storing section configured to store a user name and a password of an authenticated user;
an image processing section configured to execute processing instructed by the user; and
a managing section configured to permit operation of the image processing section according to the user name and the password of the accessing user.

2. The apparatus of claim 1, wherein the managing section does not inform the user of processing with use limitation when the storing section does not store the user name and the password of the user.

3. The apparatus of claim 1, wherein the managing section omits the authentication when the storing section stores the user name and the password of the user.

4. The apparatus of claim 3, wherein the managing section searches for operation of the image processing section that should be permitted to the user according to a period from a last access when the storing section stores the user name and the password of the user.

5. The apparatus of claim 1, wherein the managing section can be independently prepared on an outside.

6. The apparatus of claim 5, wherein the managing section does not inform the user of processing with use limitation when the storing section does not store the user name and the password of the user.

7. The apparatus of claim 5, wherein the managing section omits the authentication when the storing section stores the user name and the password of the user.

8. The apparatus of claim 7, wherein the managing section searches for operation of the image processing section that should be permitted to the user according to a period from a last access when the storing section stores the user name and the password of the user.

9. A system for image forming comprising:
a managing apparatus configured to permit an accessing user to perform processing by a specific apparatus, the managing apparatus including:
a storing section configured to store a user name and a password of an authenticated user; and
a managing section configured to permit, according to the user name and the password of the accessing user, execution of an application of an apparatus and a function that the user is permitted to use;
a first apparatus configured to execute the permitted processing in response to the access of the user, the first apparatus including:
a communicating section configured to acquire operation permitted to the user from the managing section; and
an image processing section configured to execute processing instructed by the user; and
a second apparatus configured to execute the permitted processing in response to the access of the user, the second apparatus including:
a communicating section configured to acquire operation permitted to the user from the managing section; and
an image processing section configured to execute processing instructed by the user.

10. The system of claim 9, wherein the managing apparatus does not inform the user of processing and a name of the apparatus with use limitation when the storing section does not store the user name and the password of the user.

11. The system of claim 9, wherein the managing apparatus omits the authentication when the storing section stores the user name and the password of the user.

12. The system of claim 11, wherein the managing apparatus searches for operation of the image processing section that should be permitted to the user according to a period from a last access when the storing section stores the user name and the password of the user.

13. The system of claim 10, wherein the managing apparatus informs the user of processing and a name of the apparatus that the user is permitted to use.

14. The system of claim 13, wherein the managing apparatus omits the authentication when the storing section stores the user name and the password of the user.

15. The system of claim 14, wherein the managing apparatus searches for operation of the image processing section that should be permitted to the user according to a period from a last access when the storing section stores the user name and the password of the user.

16. A method for notifying use permission of a system of an image forming network, the method comprising:
searching for, on the basis of a user name and a password of an accessing user, execution of an application of an apparatus and a function that the user is permitted to use; and
informing the accessing user of the apparatus and the function available to the user.

17. The method of claim 16, further comprising not informing the user of processing and a name of an apparatus with use limitation when a storing section does not store the user name and the password of the user.

18. The method of claim 16, further comprising omitting authentication for the user when a storing section stores the user name and the password of the user.

19. The method of claim 18, further comprising searching for operation of an image processing section that should be permitted to the user according to a period from a last access when the storing section stores the user name and the password of the user.

20. The method of claim 16, further comprising informing the user of processing and a name of an apparatus that the user is permitted to use.
